(19) United States
(12) Patent Application Publication
(10) Pub. No.: US 2004/0015353 A1
(43) Pub. Date: Jan. 22, 2004

(54) Voice recognition key input wireless terminal, method, and computer readable recording medium therefor

(75) Inventors: Hye-Yeon Kim, Seoul (KR); Chang-Dae Bang, Seoul (KR)

Correspondence Address: SUGHRUE MION, PLLC, 2100 PENNSYLVANIA AVENUE, N.W., WASHINGTON, DC, 20037, US

(73) Assignee: Samsung Electronics Co., Ltd.

(21) Appl. No.: 10/309,207

(22) Filed: Dec. 4, 2002

(30) Foreign Application Priority Data
Jul. 20, 2002 (KR) 2002-42760

(51) Int. Cl. G10L 15/00

(52) U.S. Cl. 704/246

(57) ABSTRACT

A voice recognition key input wireless terminal, a method and a computer readable medium therefor are provided. The voice recognition key input wireless terminal includes a key input unit having a voice recognition switching key, which switches the wireless terminal to a voice input mode, a voice key definition unit in which a voices corresponding to keys of the key input unit are registered, a voice recognition unit which recognizes an uttered voice of a user and determines whether the uttered voice has been registered in the voice definition unit if the voice recognition switching key is pressed when a key input request is received from a voice information provider during a connection to the voice information provider; and a key value conversion unit, which converts the uttered voice into a corresponding key tone if the uttered voice has been determined as a registered voice.

### BACKGROUND OF THE INVENTION

1. Field of the Invention

The present invention relates to a voice recognition key input wireless terminal, a method for using voice and a voice command in place of a key input in a wireless terminal, and a recording medium therefor.

The present invention is based on Korean Patent Application No. 2002-42760, filed Jul. 20, 2002, which is incorporated herein by reference.

2. Description of the Related Art

In the related art, receiving information or processing a task through a portable terminal (e.g., checking voice mail, using ARS and telebanking service) requires additional actions of pressing a key after keeping the portable terminal away from a user's ear when a key input is required for a call.

More specifically, to select a function of checking voice mail, a user needs to press a corresponding number. When selecting options while using ARS (e.g., audiotex service), the user needs also to press a corresponding number or input passwords, telephone number or a social security number. This is also the case for using telebanking service, which requires inputting a user's telephone number, social security number, passwords, or an account number.

Receiving information using a conventional ARS system consists of the steps of connecting to ARS by dialing an ARS telephone number, inputting a corresponding menu or number through a keypad according to an audio response, and hearing information corresponding to the menu inputted through the keypad. FIG. 1 illustrates a process of receiving information according to a conventional ARS system. First, a user hooks off a communication terminal (step S110) at first, then dials an ARS telephone number (step S120), and then receives an audio response from the other station after connecting thereto (step S130).

Next, the user inputs a dial digit according to the audio response (step S140). The inputted dial digit is sent to the station (step S150) and the user receives an audio response again. When the dial digit is not input any more, the connection to ARS is stopped and the portable terminal is set to a standard use state (step S160).

However, the aforementioned related art has various problems and disadvantages. For example, but not by way of limitation, when inputting a key through the keypad while using the conventional ARS system, since a user's face contacts with the portable terminal, the user must keep the portable terminal away from his/her ear, input the key and then hold the terminal to the ear again as soon as possible. As a result, the user experiences inconvenience in inputting the key during a call and thus misses the information that should be heard before and after inputting the key.

Moreover, if there are too many numbers to be input or difficulties in memorizing the numbers, there exists a high probability of inputting incorrect keys. Also, if a user often uses a certain ARS service, repetitively inputting many numbers each time is a bothersome task to the user.

The method “Method for Editing by Employing Voice Recognition in a Wireless Terminal”, disclosed in Korean Laid-open Patent No. 2000-44446 (dated Jul. 15, 2000) relates to a function of editing a telephone book or a schedule in a wireless terminal. In this patent, if a character input mode is selected, a user's voice is inputted, and a corresponding character is displayed and stored if voice data corresponding to the user's voice exists in a memory. Unless voice data corresponding to the inputted voice of the user exists in the memory, a warning message is outputted. Therefore, this patent publication applies voice recognition to using an editing function in a wireless terminal.

Also, the apparatus and method “Apparatus and Method for Registering a Telephone Number Automatically through Voice Recognition during a Call”, disclosed in Korean Laid-open Patent No. 2001-64722 (dated on Jul. 11, 2001) relates to an automatic registration of a telephone number through voice recognition during a call. In this patent, if a user commands voice registration of a telephone number during a call, voice recognition of the telephone number which the other party transmits as voice is performed and the telephone number is registered and stored automatically in an empty area of the memory assigned to store telephone numbers. Therefore, this patent also applies voice recognition to registering a telephone number transmitted from the other party during a call in a memory.

### SUMMARY OF THE INVENTION

To solve at least the above-described and related problems, it is an object of the present invention to provide a voice recognition key input wireless terminal, a method for using voice in place of a key input in a wireless terminal, and a recording medium therefor, to facilitate a key input by inputting key through voice when the key input is required in a wireless terminal.

It is another object of the present invention to provide a method for using a voice command in place of a key input in a wireless terminal, and recording medium therefor, to facilitate a key input demanding input of many numbers by registering previously a specific command corresponding to a key value which needs repetitive inputs, and speaking the corresponding command when the key input is required.

Accordingly, in an aspect, the present invention provides a voice recognition key input wireless terminal, comprising a key input unit having a voice recognition switching key, which switches the wireless terminal to a voice input mode, a voice key definition unit in which a voice corresponding to a key of the key input unit is registered, a voice recognition unit which recognizes an uttered voice of a user and determines whether the uttered voice has been registered in the voice definition unit if the voice recognition switching key is pressed when a key input request is received from a voice information provider during a connection to the voice information provider; and a key value conversion unit, which converts the uttered voice into a corresponding key tone if the uttered voice has been determined as a registered voice.

Preferably, the voice key definition unit comprises a standard key definition unit in which keys of the key input unit are registered with standard voices; and an extended key definition unit in which a series of keys is registered with a user defined registration command.

Preferably, the voice recognition switching key can be realized by an existing key in the key input unit by software or with an additional dedicated key in the key input unit.

In another aspect, the present invention provides a method for using voice in place of a key input in a wireless terminal, including (a) determining if the voice recognition that switches the terminal into a voice input mode is inputted when a key input request is received from a voice information provider during a connection to the voice information provider, (b) receiving and performing voice recognition of a uttered voice of a user if the voice recognition switching key is pressed as a result of act (a), (c) determining whether the uttered voice corresponding to a key of the key input unit corresponds to voice registered in the voice key definition unit as a result of act (b), and (d) converting the uttered voice into a corresponding key tone and transmitting the converted key tone to the uttered voice information provider if the voice has been determined as a registered voice.

Preferably, the method further comprises outputting a predetermined warning sound or guidance sound unless the uttered voice has been determined as registered voice.

Preferably, the voice key definition unit comprises a standard key definition unit which registers keys of the key input unit with standard uttered voices and an extended key definition unit which registers a series of keys as an extended key.

Preferably, the voice recognition switching key can be realized by existing keys in the key input unit by software or with an additional dedicated key in the key input unit.

In another aspect, the present invention provides a method for using a voice command in place of a key input in a wireless terminal, including (a) receiving a uttered voice command of a desired extended key command and the key input corresponding to the extended key command and registering an extended key, (b) determining whether the voice recognition switching key that switches the terminal to the voice input mode is pressed, when a key input request is received during a connection to other party, (c) receiving and performing voice recognition of the uttered voice command if the voice recognition switching key is pressed as a result of act (b), (d) determining whether the recognized voice is a registered extended key command, and (e) converting the uttered voice command into corresponding key tone and transmitting the converted voice command to a voice information provider if the voice has been determined as registered.

In another aspect, the present invention provides a computer readable medium having embodied thereon a computer program enabling a computer to provide a service for using voice in place of a key input in a wireless terminal, the service comprising steps of (a) determining if the voice recognition that switches the terminal into a voice input mode is inputted when a key input request is received from a voice information provider during a connection to the voice information provider, (b) receiving and performing voice recognition of an uttered voice of a user if the voice recognition switching key is pressed as a result of act (a), (c) determining whether the uttered voice corresponding to a key of the key input unit corresponds to voice registered in the voice key definition unit as a result of act (b), and (d) converting the uttered voice into corresponding key tone and transmitting the converted key tone to the uttered voice information provider if the voice has been determined as registered.

### BRIEF DESCRIPTION OF THE DRAWINGS

The above objects and advantages of the present invention will become more apparent by describing in detail preferred embodiments thereof with reference to the attached drawings in which:

FIG. 1 is a flowchart of a related art dial sending process for responding to a conventional ARS;

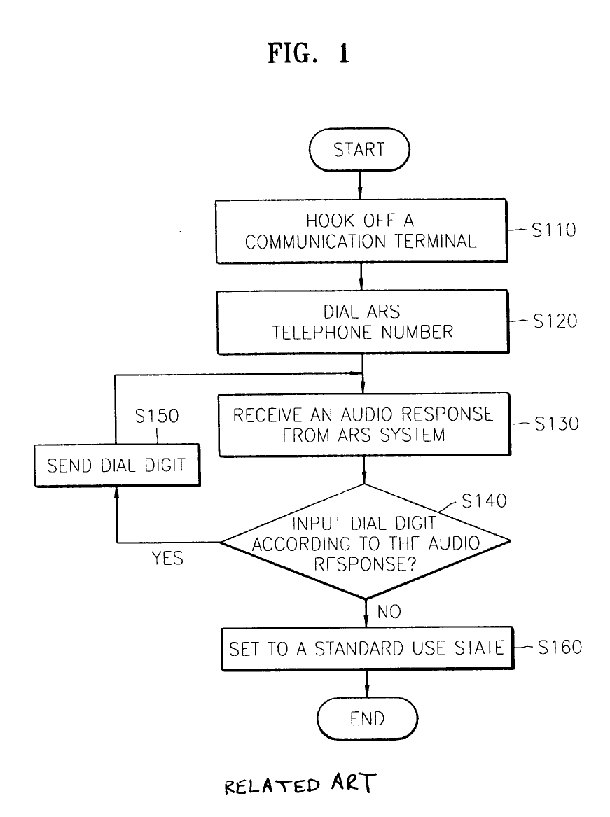

FIG. 2 is a schematic block diagram of a structure for a voice recognition key input wireless terminal according to the present invention;

FIG. 3 is a view for explaining contents registered in the voice key definition unit of FIG. 2;

FIG. 4 is a flow chart of an operational process for a voice recognition key input wireless terminal according to the present invention;

FIG. 5 is a flow chart of a process for registering an extended key for a voice recognition key input wireless terminal according to the present invention.

### DETAILED DESCRIPTION OF THE INVENTION

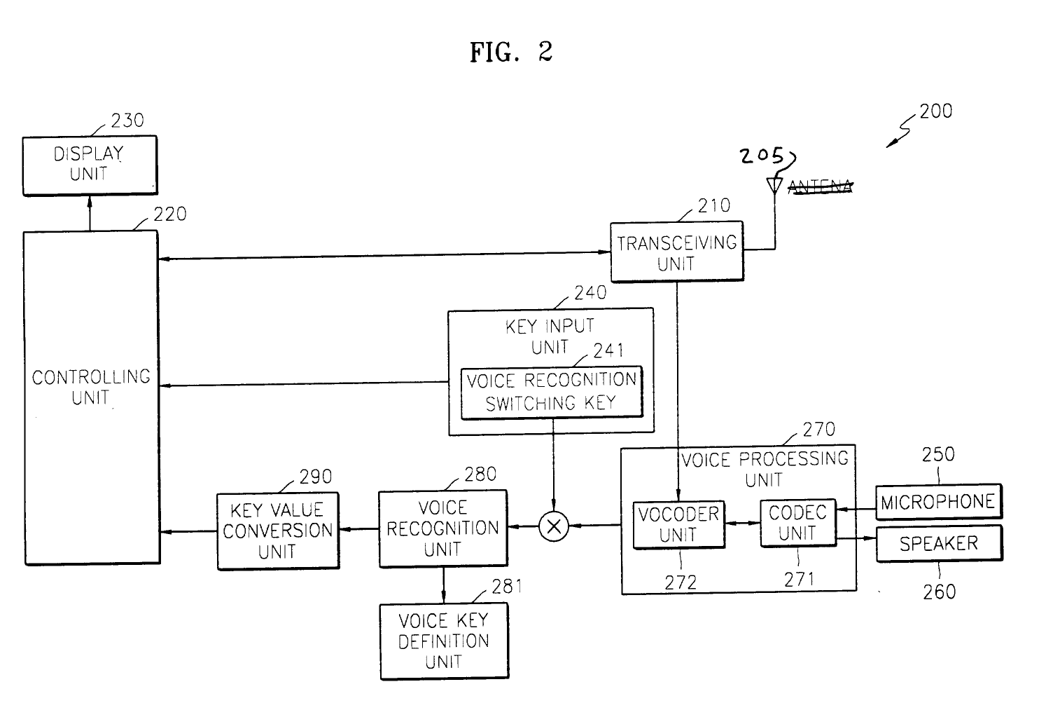

An embodiment of a structure of a voice recognition key input wireless terminal 200 is illustrated in FIG. 2. The terminal 200 includes an antenna 205, a transceiving unit 210, a controlling unit 220, a display unit 230, a key input unit 240, a microphone 250, a speaker 260, a voice processing unit 270, a voice recognition unit 280, a voice key definition unit 281 and a key value conversion unit 290.

The transceiving unit 210 transceives data between the wireless terminal 200 and a base station (not shown). The controlling unit 220 controls the whole process and operation of the wireless terminal 200. The display unit 230 displays a current state using e.g., a LCD device.

The voice recognition switching key 241 included in the key input unit 240 is a dedicated key for voice recognition, and is used only for switching into a voice input mode, not for transmitting a key value when the voice recognition switching key is pressed in a state of connection.

The voice processing unit 270 processes a received signal from the transceiving unit to output a processed signal to the speaker 260, and processes a received signal from the microphone 250 to transmit to the transceiving unit 210. A codec unit 271 included in the voice processing unit 270 converts analog data inputted from the microphone into the forms of codes, and a vocoder unit 272 converts the data from the codec unit into a packet that can be transmitted.

The voice recognition unit 280 performs voice recognition of data received from the voice processing unit 270. The key value conversion unit 290 converts the result of the voice recognition from the voice recognition unit 280 into a corresponding key tone.

The voice key definition unit 281 is a memory defined by making the standard voice or the uttered voice correspond to the predetermined key in the key input unit 240.

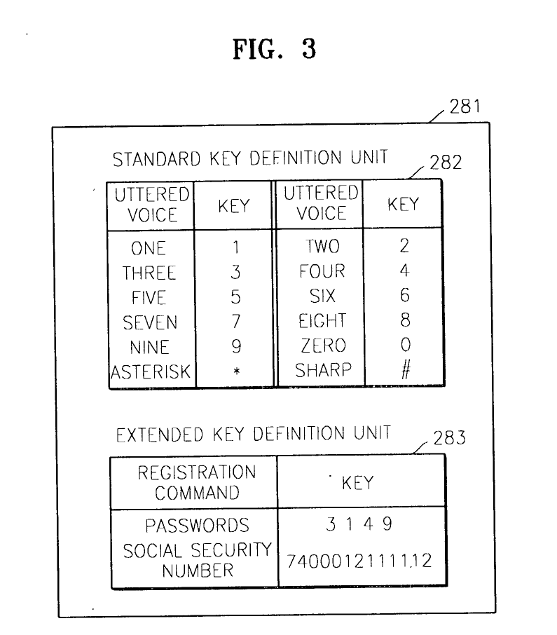

The detailed structure of the voice key definition unit 281 is illustrated in FIG. 3. The voice key definition unit 281 comprises a standard key definition unit 282 and an extended key definition unit 283.

Since the uttered voice has a one to one correspondence with a key of the key input unit in the standard key definition unit 282, additional registration is not required. For example, but not by way of limitation, it has been already registered to correspond the standard uttered voice “one” to the key “1” of the key input unit and the standard uttered voice “sharp” to the key “#”.

The extended key definition unit 283 is used when a user utters a command for his/her purpose, and registers an uttered command and a key corresponding to the command. For example, a user says “passwords” and presses “3149” to register “3149” as “passwords”. Then, the user obtains the same effect as pressing keys “3149” of the key input unit by just speaking “passwords” without pressing number keys directly.

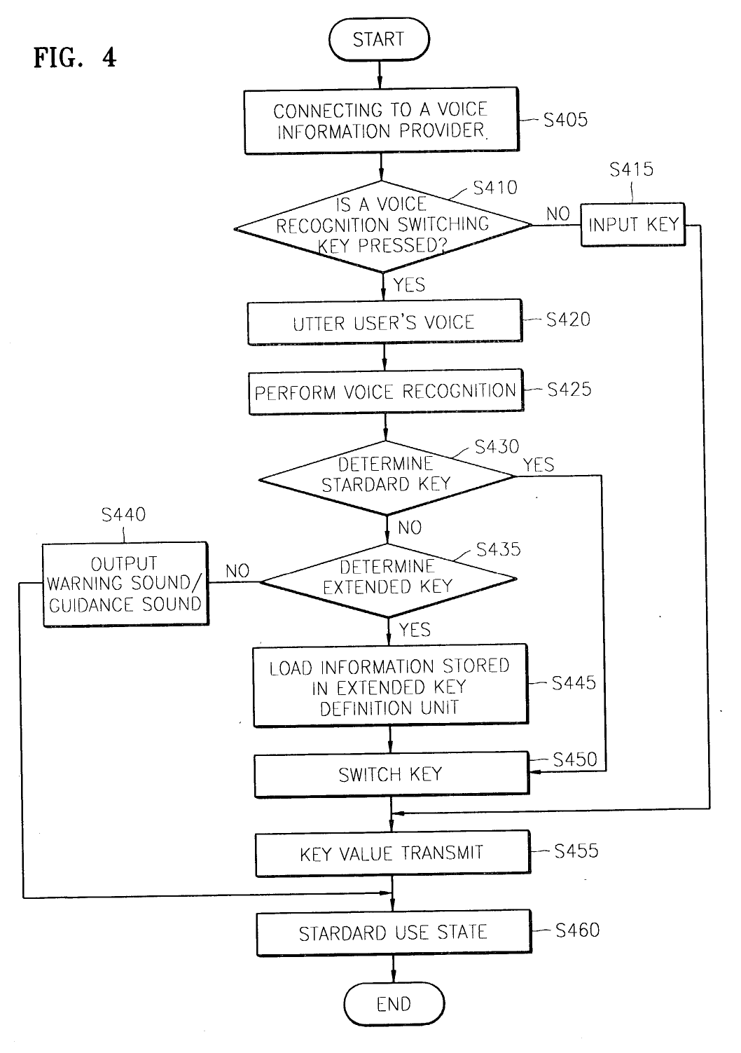

FIG. 4 is a flow chart of an operational process for a voice recognition key input wireless terminal according to the present invention. After being connected to a voice information provider like the ARS (step 405), it is determined whether the voice recognition switching key has been pressed, when the voice information provider requests a selection of option or an input of passwords, and so the user is required to input keys (step S410).

As a result of the determination at step S410, unless the voice recognition switching key is pressed, an input key in a standard use state is received (step S415) to then proceed to a step S455.

As a result of determining at step S410, if it has been determined that the voice recognition switching key 241 of the key input unit 240 has been pressed, the terminal is set to a voice recognition mode. Then, a user utters a voice command (step 240) instead of pressing a key of the key input unit. The user's voice data received through the microphone 250 is processed by the voice processing unit 270 and is transmitted to the voice recognition unit 280.

Thus, the voice recognition unit of the terminal recognizes the user's voice (step S425) and determines whether the key corresponding to the user's voice is a standard key registered in the voice key definition unit 281 (step S430). As a result of the determination in step S430, if the key is the standard key registered in the standard key definition unit 282, the program proceeds to step S450. At that point, the uttered voice data is converted into a key value (step S450), and the key value is transmitted (step S455).

In the step S430, if the key is not the standard key, it is determined whether the key is an extended key registered in the extended key definition unit 283 (step S435). If the key is not the extended key, the key that the user has uttered does not exist in the voice key definition unit. Therefore, a warning sound or guidance sound is outputted (step S440).

In the meantime, if the key is determined to be an extended key at step S435, information stored in the extended key definition unit is loaded (step S445) and the key value conversion unit 290 converts the loaded data into a key value (step S450). Then, the key value is transmitted to a system of the voice information provider (step S455) and the terminal is set to a standard use state (step S460).

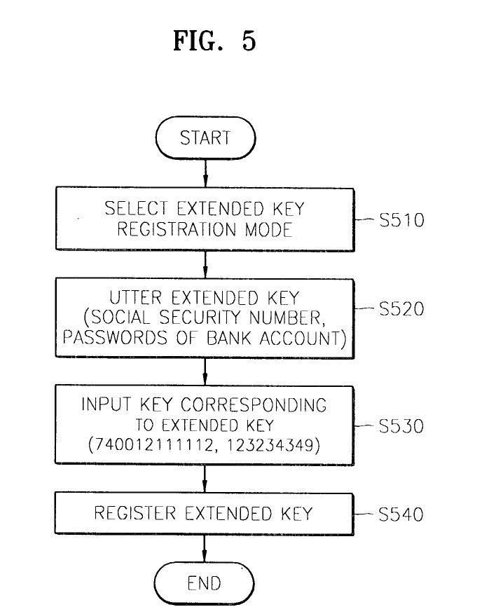

FIG. 5 is a flow chart of a process for registering the extended key in a voice recognition key input wireless terminal according to the present invention. The standard key definition unit is usually made in the course of manufacturing a wireless terminal. However, the extended key definition unit can be made by corresponding a desired number to the registration command.

First, the user selects the extended key registration mode provided by a wireless terminal (step S510) and utters the extended key command according to his/her purpose (step S520). For example, but not by way of limitation, when the numbers to be inputted are too many or difficult to memorize, such as a social security number or a password of a bank account, it is very bothersome to input all of the numbers each time. Therefore, in the present invention, to register such numbers in the terminal, the user utters the command, “social security number” at step S520. Then, the user inputs keys corresponding to the uttered command through the key input unit (step S530).

As a result, the command of the extended key and keys corresponding to the extended key are inputted and the controlling unit of the wireless terminal registers the inputted command and the corresponding keys in the voice key definition unit (step S540) as shown in FIG. 3. At this point, a detailed interface of a registration mode of the extended key may be varied according to the user's conveniences.

In another non-limiting, exemplary embodiment, the present invention also can be realized in the forms of codes in a recording medium, and the recording medium can be read by a computer. The recording medium includes various recording devices for storing data that the computer system can read. Such recording media are ROM, RAM, CD-ROM, magnetic tape, floppy disk, and optical data storage, but the present invention is not limited thereto. Also, transmissions via the Internet (e.g., carrier wave) can be included in the recording media. The recording medium can be distributed in a computer system connected to a network, and can be stored and operated in the forms of codes read through the distributed computer system.

The above-described exemplary embodiments have various advantages. For example, but not by way of limitation, as described above, according to a voice recognition key input wireless terminal, it is possible to settle the inconveniences caused when the user has to keep the terminal away from his/her ear in order to press a keypad during a call. Also, the terminal prevents loss of the voice information that is missed while the user is pressing the keypad.

In addition, when it is required to register the frequently used numbers or many numbers with a command previously and press those numbers, the user can input keys in the keypad by just uttering commands with increasing the user's conveniences.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A voice recognition key input wireless terminal, comprising:
a key input unit having a voice recognition switching key that switches the wireless terminal to a voice input mode;
a voice key definition unit in which a voice corresponding to a key of the key input unit is registered;
a voice recognition unit which recognizes a voice of a user and determines whether the voice has been registered in the voice definition unit if the voice recognition switching key has been pressed when a key input request is received from a voice information provider; and
a key value conversion unit, which converts the uttered voice into a corresponding key tone if the voice has been determined to be registered.

2. The wireless terminal of claim 1, wherein the voice key definition unit comprises:
a standard key definition unit in which the key of the key input unit is registered with a standard voice; and
an extended key definition unit in which a series of keys is registered with a user defined registration command.

3. The wireless terminal of claim 1, wherein the voice recognition switching key can be realized by an existing key in the key input unit by software or with an additional dedicated key in the key input unit.

4. A method for inputting a key using voice in a wireless terminal, comprising:
(a) determining if the voice recognition that switches the terminal into a voice input mode is inputted when a key input request is received from a voice information provider during a connection to the voice information provider;
(b) receiving and performing voice recognition of an uttered voice if the voice recognition switching key is pressed as a result of step (a);
(c) determining whether the uttered voice corresponding to a key of a key input unit corresponds to a voice registered in the voice key definition unit as a result of step (b); and
(d) converting the uttered voice into corresponding key tone and transmitting the converted key tone to the uttered voice information provider if the voice has been determined as registered voice.

5. The method of claim 4, further comprising outputting a predetermined sound unless the uttered voice has been determined as registered voice.

6. The method of claim 4, wherein in the voice key definition unit;
a standard key definition unit registers keys of the key input unit with standard uttered voices; and
an extended key definition unit registers a series of keys as an extended key.

7. The method of claim 4, wherein the voice recognition switching key is realized by existing keys in the key input unit by software or with an additional dedicated key in the key input unit.

8. A method for using a voice command in place of a key input in a wireless terminal, the method comprising:
(a) receiving an uttered voice command of a desired extended key command and the key input corresponding to the extended key command and registering an extended key;
(b) determining whether the voice recognition switching key that switches the terminal to the voice input mode is pressed, when a key input request is received during a connection to another party;
(c) receiving and performing voice recognition of the uttered voice command if the voice recognition switching key is pressed as a result of step (b);
(d) determining whether the recognized voice is a registered extended key command; and
(e) converting the uttered voice command into corresponding key tone and transmitting the converted voice command to a voice information provider if the voice has been determined as registered.

9. A computer readable medium having embodied thereon a computer program enabling a computer to provide a service for using voice in place of a key input in a wireless terminal, the computer program performing the steps of:
(a) determining if the voice recognition that switches the terminal into a voice input mode is inputted when a key input request is received from a voice information provider during a connection to the voice information provider;
(b) receiving and performing voice recognition of a uttered voice of a user if the voice recognition switching key is pressed as a result of step (a);
(c) determining whether the uttered voice corresponding to a key of the key input unit corresponds to voice registered in the voice key definition unit as a result of step (b); and
(d) converting the uttered voice into corresponding key tone and transmitting the converted key tone to the uttered voice information provider if the voice has been determined as registered.

10. The computer readable medium of claim 9, wherein said computer program further performs the step of outputting a predetermined sound unless the uttered voice has been determined as a registered voice.

11. The computer readable medium of claim 10, wherein said predetermined sound is at least one of a warning sound and a guidance sound.

12. The computer readable medium of claim 9, wherein in the voice key definition unit;
a standard key definition unit registers keys of the key input unit with standard uttered voices; and
an extended key definition unit registers a series of keys as an extended key.

13. The compute readable medium of claim 9, wherein the voice recognition switching key is realized by existing keys in the key input unit by software or with an additional dedicated key in the key input unit.

14. The computer readable medium of claim 5, wherein said predetermined sound is at least one of a warning sound and a guidance sound.
